(19) United States
(12) Patent Application Publication
(10) Pub. No.: US 2011/0184540 A1
(43) Pub. Date: Jul. 28, 2011

(54) VOLUME ADJUSTING METHOD FOR DIGITAL AUDIO SIGNAL

(75) Inventor: CHAO-WEI HUANG, TAINAN (TW)

(73) Assignee: HIMAX MEDIA SOLUTIONS, INC., TAINAN (TW)

(21) Appl. No.: 12/695,450

(22) Filed: Jan. 28, 2010

(51) Int. Cl. G06F 17/00

(52) U.S. Cl. 700/94

(57) ABSTRACT

A method for adjusting the volume of a digital audio signal includes detecting a level in accordance with an audio input signal, determining a gain value in accordance with the detected level, and outputting an audio output signal in accordance with the gain value and the audio input signal. Accordingly, weak audio signals such as background noise in silent periods may be compressed to reduce interference to the human listening experience during such silent periods.

### BACKGROUND OF THE INVENTION

1. Field of the Invention

The present invention generally relates to a volume adjusting method for an audio signal, and more particularly, to a volume adjusting method for an audio signal having a weak peak value or energy level in order to reduce the background noise in a multimedia system.

2. Description of Related Art

FIG. 1 is a diagram illustrating a conventional multimedia audio processing system. As shown in the layout, a conventional audio processing system 10 can include a tuner input 102, analog-to-digital converters (ADCs) 104, a demodulator 106, such as an analog Sound If (SIF) demodulator, for example, an analog input 108, a digital input 110, a decoder 112, a digital audio signal processing apparatus 114, a digital-to-analog converter (DAC) 116, and a digital output 118. The audio input may be sourced from the tuner 102, the analog input 108, or the digital input 110. Audio input from the tuner 102 or the analog input 108 is the analog audio source, for which analog-to-digital conversion is needed and may be performed by the ADCs 104. Audio sourced from the tuner 102 is further demodulated by the demodulator 106 after digitalization. It is necessary for audio input from the digital input 110 to be decoded before transmittal to the digital audio signal processing apparatus 114. The digital audio signal processing apparatus 114 may be used to process the audio input from the tuner 102, the analog input 108, and/or the digital input 110. Finally, the audio signal is output from the digital audio signal processing apparatus 114 to the DAC 116 or a digital output 118.

However, the analog signal can be easily affected by interference such as noise during transmitting and processing so as to cause the signal-to-noise ratio (SNR) to be reduced. Although human ears may not be as keenly aware of the existence of background noise during regular, high-volume, or high output periods of the music or audio (e.g., in-play periods), when the music or audio is at lower volumes or outputs, or not in play, it becomes relatively easy for human ears to recognize the background noise, thus negatively interfering with the listening experience.

Accordingly, there is a need to design a system to determine the background noise when the normal audio is in low-output or mute and adjust the sound to reduce the noise interference detectable by human ears.

### SUMMARY OF THE INVENTION

It is an object of the embodiments to provide a digital audio signal processing system and related method to compress and mute audio signals when the volume of the audio source is very weak in order to reduce background noise interfering in a multimedia audio system.

According to the object described above, a digital audio signal processing apparatus includes a level detector used to detect a level in accordance with an audio input signal, a gain table used to determine a gain value in accordance with said detected level, and a gain controller used to output an audio output signal in accordance with said gain value and said audio input signal.

According to the object described above, a method for adjusting volume of a digital audio signal includes detecting a level in accordance with an audio input signal, determining a gain value in accordance with said detected level, and outputting an audio output signal in accordance with said gain value and said audio input signal.

### BRIEF DESCRIPTION OF THE DRAWINGS

FIG. 1 is a diagram illustrating a conventional audio processing system;

FIG. 2 is a block diagram illustrating a digital audio signal processing apparatus according to an embodiment of the present invention;

FIG. 3 is a diagram illustrating the relationship between the gain value and the detected level of the audio input signal;

FIG. 4 is a flow chart of the embodiment of an audio signal processing method according to the present invention; and

FIG. 5 is a flow chart illustrating how the gain value is determined according to another embodiment of the present invention.

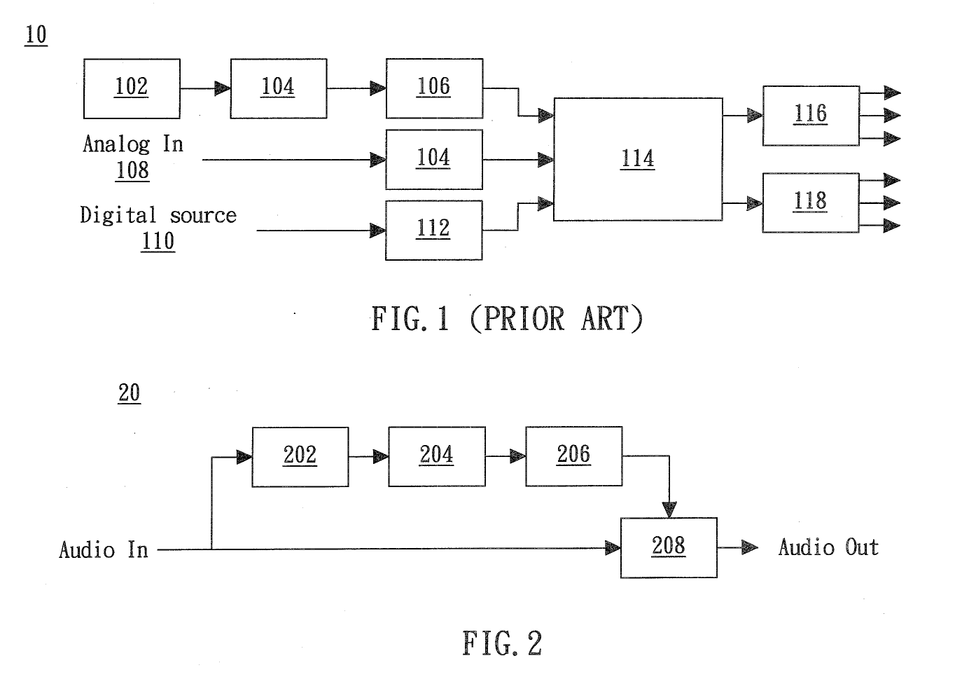

### DETAILED DESCRIPTION OF THE INVENTION

FIG. 2 is a block diagram illustrating a digital audio signal processing apparatus according to an embodiment of the present invention. As shown in the embodiment, the digital audio signal processing apparatus 20 includes a filter 202, a peak level detector 204, a gain table 206, and a gain controller 208. When the digital audio signal processing apparatus 20 receives an audio input signal, the filter 202 filters the high frequency part because human ears are not sensitive to frequencies higher than about 20 KHz. The filter 202 in a preferred embodiment may be a low pass filter or a band pass filter. Afterward, the filtered audio input signal is transmitted into the peak level detector 204 to detect the peak level of the filtered audio input signal. The digital audio signal processing apparatus 20 may then perform a look-up function using the gain table 206 in accordance with the peak level detected by the peak level detector 204 to determine a gain value. The gain controller 208 may then output an audio output signal in accordance with the gain value and the audio input signal. In a preferred embodiment, the audio output signal is the product of (i.e., is obtained by multiplying) the audio input signal and the gain value.

In another embodiment of the present invention, the digital audio signal processing apparatus may have the same structure as the digital audio signal processing apparatus 20 shown in FIG. 2, with an energy level detector in substitution for the peak level detector. The gain table adopted may provide a gain value corresponding to the detected energy level of the filtered audio input signal instead. The digital audio signal processing apparatus in this embodiment may then perform a look-up function using the gain table in accordance with the energy level detected by the energy level detector to determine a gain value. In the other embodiment, the digital audio signal processing apparatus may have a similar structure as the digital audio signal processing apparatus 20 shown in FIG. 2, with an energy level detector or a peak level detector, but with the audio output signal being obtained from multiplying the filtered audio input signal, output from the filter, but not the original audio input signal, by the gain value.

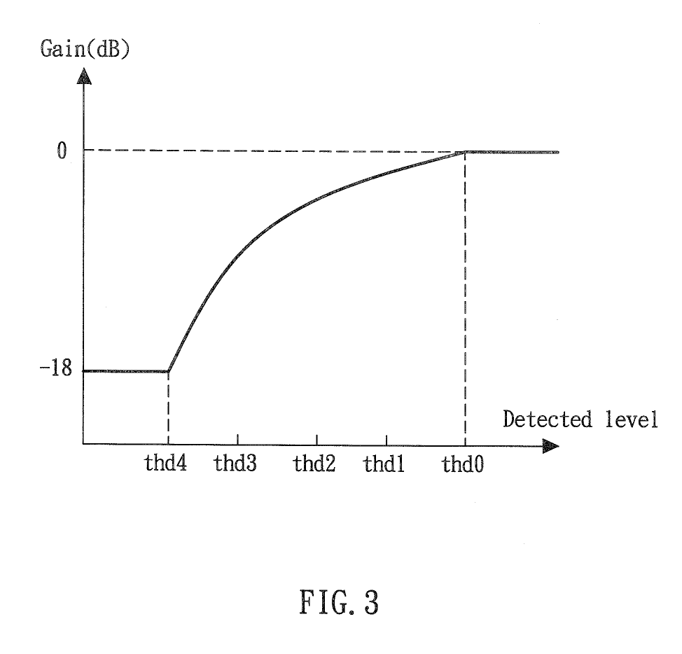

FIG. 3 is a diagram illustrating a relationship between the gain value and the detected peak level of the audio input signal. As shown in the plot, according to a preferred embodiment, the detected peak level of the audio input signal is divided into five intervals by five different levels (thd0 to thd4). Basically, the curve illustrated in FIG. 3 shows the gain controller in the digital audio signal processing apparatus of the present invention may be a gain compressor for the signal with a low peak level. It is seen that, in the exemplary embodiment corresponding to FIG. 3, for an audio signal of which the detected peak level is between thd0 and thd4, the lower the detected level, the more the signal is compressed. There is a predetermined lower bound gain value, −18 dB, for example, for the signals of which the peak level is detected lower than thd4 in the embodiment shown in FIG. 3. It should be noted that there may be more or less than five intervals for detected peak levels in different embodiments. Further, for the digital audio signal processing apparatus of the present invention that adopts an energy level detector rather than a peak level detector, the curve diagram of FIG. 3 may represent the relationship between the gain value and the detected energy level.

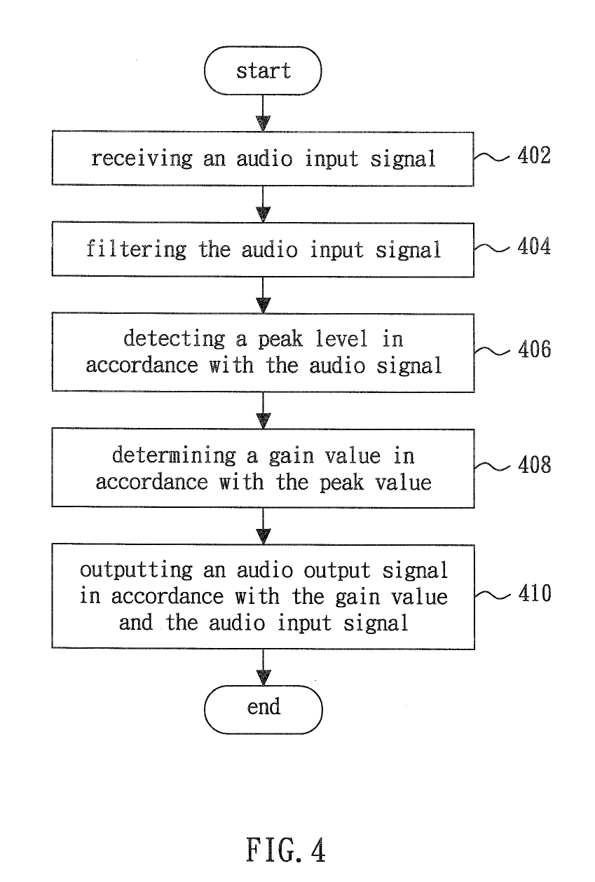

FIG. 4 is a flow chart exemplifying the digital audio signal processing method of the present invention. According to the depicted flow, in step 402, the digital signal processing system receives an audio input signal. The audio input signal may be analog or digital, and may be of different standards according to different systems. In step 404, the audio input signal is filtered for a better result in the following process. In the exemplary embodiment, the higher frequency part of the audio input signal is filtered. In step 406, a peak level of the filtered audio signal is detected. In step 408, a gain value is determined in accordance with the detected peak level. One of the ways to determine a gain value in step 408 is to reference a gain table corresponding to the detected peak level. In step 410, an audio output signal is output with volume adjusted in accordance with the gain value and the audio input signal. For example, the audio output signal may be generated by the gain value being multiplied with the audio input signal in a gain controller. With a compressing gain value, the volume of the audio output signal is decreased. For the audio input signal of which the detected peak level is lower than a predetermined threshold, the corresponding gain value may be as low as feasible to mute the audio output signal.

In another embodiment of the present invention, step 406 may be replaced by (and/or combined with) detecting an energy level of the audio input signal instead of (or in addition to) a peak level of the same. Therefore, step 408 hence may be changed to determining a gain value in accordance with the detected energy level. In other embodiments of the present invention, step 410 may be changed to output the product of the gain value and the filtered audio input signal generated in step 404.

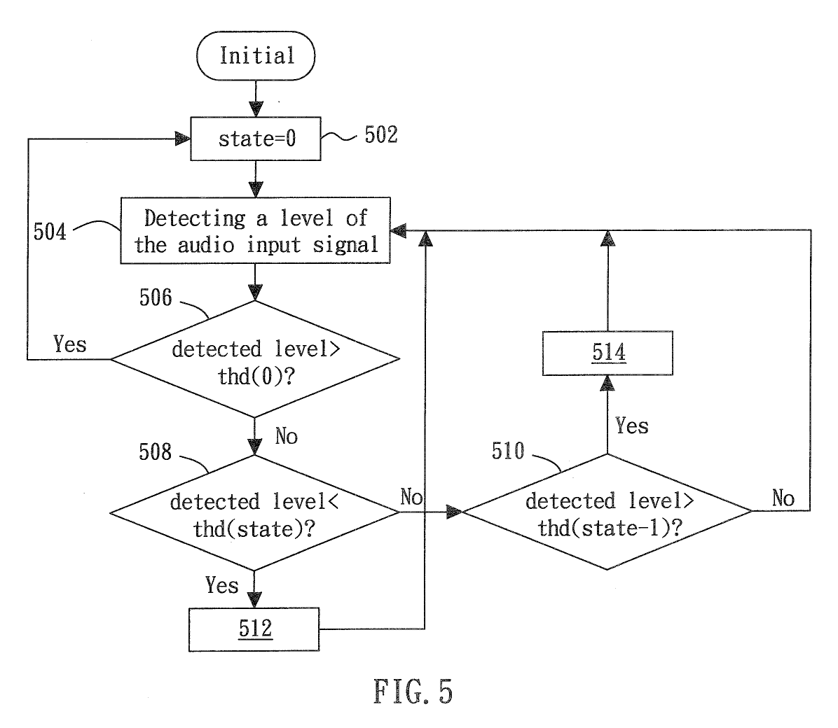

The present invention may further comprise adjusting the volume of the audio signal according to how long the level of the audio signal lasts (e.g., in a low state, continuously). A state value is adopted for this function. FIG. 5 is a flow chart illustrating how the gain value can be decided in this embodiment of the present invention. As shown, the state value is set at zero (state=0) initially in step 502, and the corresponding gain value is a unit gain, which means no volume compression of the audio output signal is performed. In step 504, a peak level or an energy level of the audio input signal, depending on the design, is detected. If the detected level is larger than an initial state threshold level (thd0), the state value keeps zero and the flow goes back to step 502 for the next observation duration. If the detected level is not larger than the initial state threshold level (thd0), the flow then goes to step 508. In step 508, the detected level is further checked if it is lower than the current state threshold level. If the detected level is smaller than the current state threshold level, step 512 is performed. Otherwise, step 510 is performed instead. In step 512, the state value is accumulated (e.g., incremented) by one before the state value exceeds a predetermined upper limit, and the gain value is then set in accordance to the state value. The flow then goes back to step 504 for the next observation duration. If in step 508, the detected level is not lower than the current state threshold level, it is checked in step 510 to determine if the detected level is higher than the previous state threshold level. If the detected level is not higher than the previous state threshold level, the flow goes to step 504 for the next observation duration, and the gain value is set according to the current state value. If the detected level is higher than the previous state threshold level, the state value is decreased by one in step 514 for it means (e.g., meaning, or corresponding to a condition in which) the detected level, no matter (e.g., without regard to) the peak level or the energy level (the volume level), is increasing. Moreover, if the state value reaches the upper limit and the detected level is lower than the current state (the upper limit state) threshold level, the state value remains the same in step 512 for it is observed that (e.g., meaning, or corresponding to a condition in which) the audio signal is very weak, possibly just a background noise in a silent or lower-output period (e.g., a period of one or more of reduced decibels, reduced volume, reduced audible sound, reduced music or speaking, muted state, and reduced output or gain), and the corresponding gain value is set to the predetermined lower bound value to mute the audio output signal.

Still referring to FIG. 5, whenever the detected level is found to be higher than the initial state threshold level (thd0) in step 506, it is determined that the audio input sound is not in a silent period. The gain value is set back to a unit gain as in step 502, and no compression or muting is performed to the audio output signal.

In summary, the present invention provides an efficient process for use with audio signals, compressing or muting the volume of a weak signal, possibly likely the background noise during a low-output or silent period. Exemplary embodiments decide the gain value (the compression value) according to the detected peak level or energy level of the audio input signal, and some exemplary embodiments further refer to how long the detected level remains low as well. Related method sequences of the process are also illustrated as above with reference to the figures. According to one aspect, the detecting of a level in accordance with (e.g., of) an audio input signal (cf. step 504) is performed in each of a plurality of predetermined periods.

Although specific embodiments have been illustrated and described, it will be appreciated by those skilled in the art that various modifications may be made without departing from the scope of the present invention, which is intended to be limited solely by the appended claims.

What is claimed is:

1. A digital audio signal processing apparatus, comprising:
a level detector constructed to detect a level in accordance with an audio input signal;
a gain table containing information to facilitate determination of a gain value in accordance with said detected level; and
a gain controller configured to generate an audio output signal in accordance with said gain value and said audio input signal.

2. The digital audio signal processing apparatus of claim 1, wherein the level detector is a peak level detector constructed to detect a peak level of the audio input signal, and the gain table is arranged to facilitate determination of a gain value in accordance with said detected peak level.

3. The digital audio signal processing apparatus of claim 1, wherein the level detector is an energy level detector adapted to detect an energy level of the audio input signal, and the digital audio signal processing apparatus is configured to use the gain table to determine a gain value in accordance with said detected energy level.

4. The digital audio signal processing apparatus of claim 1, further comprising a filter coupled to filter said audio input signal and to output a filtered audio input signal, wherein the digital audio signal processing apparatus is configured to use the level detector to detect a level of the filtered audio input signal.

5. The digital audio signal processing apparatus of claim 4, wherein said filter is a low pass filter.

6. The digital audio signal processing apparatus of claim 1, wherein said audio output signal is the product of said gain value and said audio input signal.

7. The digital audio signal processing apparatus of claim 1, wherein said digital audio signal processing apparatus is coupled to be used in a multimedia system.

8. The digital audio signal processing apparatus of claim 7, wherein said digital audio signal processing apparatus is configured to use said gain controller to compress said audio output signal when the level of said audio input signal is lower than a predetermined threshold.

9. The digital audio signal processing apparatus of claim 7, wherein said digital audio signal processing apparatus is configured to use said gain controller to mute said audio output signal when the level of said audio input signal is lower than a predetermined threshold.

10. A method for adjusting volume of a digital audio signal, comprising:
detecting a level in accordance with an audio input signal;
determining a gain value in accordance with said detected level; and
generating an audio output signal in accordance with said gain value and said audio input signal.

11. The method of claim 10, wherein the step of detecting a level in accordance with an audio input signal comprises detecting a peak level in accordance with an audio input signal, and the step of determining a gain value in accordance with said detected level comprises determining a gain value in accordance with said detected peak level.

12. The method of claim 10, wherein the step of detecting a level in accordance with an audio input signal comprises detecting an energy level in accordance with an audio input signal, and the step of determining a gain value in accordance with said detected level comprises determining a gain value in accordance with said detected energy level.

13. The method of claim 10, further comprising filtering said audio input signal to reduce noise of said audio input signal.

14. The method of claim 10, wherein the step of generating an audio output signal in accordance with said gain value and said audio input signal comprises multiplying said audio input signal by said gain value and outputting the product of the multiplication.

15. The method of claim 14, wherein the gain value is a compression value such that the audio output signal is compressed when the level of said audio input signal is lower than a predetermined threshold.

16. The method of claim 14, wherein the gain value is a compression value such that the audio output signal is muted when the level of said audio input signal is lower than a predetermined threshold.

17. The method of claim 10, wherein:
the step of detecting a level in accordance with an audio input signal is performed in each of a plurality of predetermined periods;
the method further comprises adjusting a state value according to the detected level; and
the step of determining a gain value further comprising determining a gain value in accordance with the state value of said audio input signal.

18. The method of claim 17, wherein the step of adjusting a state value comprises increasing a state value when the level is detected to be lower than a predetermined value.

19. The method of claim 17, wherein a higher state value is corresponding to a lower gain value.

20. The method of claim 17, wherein when the detected level is higher than the predetermined value, the state value is set to zero.
